(19) United States
(12) Patent Application Publication
(10) Pub. No.: US 2026/0031618 A1
(43) Pub. Date: Jan. 29, 2026

(54) SYSTEM AND METHOD FOR MONITORING POWER QUALITY EVENTS

(71) Applicant: Atlas Copco Airpower, Naamloze Vennootschap, Wilrijk (BE)

(72) Inventors: Hans VANDE SANDE, Wilrijk (BE); Tijs VAN BUGGENHOUT, Wilrijk (BE); Jonas DE KOONING, Wilrijk (BE)

(21) Appl. No.: 19/267,962

(22) Filed: Jul. 14, 2025

Related U.S. Application Data
(60) Provisional application No. 63/676,651, filed on Jul. 29, 2024.

(51) Int. Cl. H02J 3/00

(52) U.S. Cl. CPC H02J 3/0012; H02J 3/00125; H02J 2203/20

(57) ABSTRACT

A system and method involve monitoring power quality events using a variable speed drive (VSD) that is electrically connected to an electrical supply grid and a motor. The system and method include sampling measurements of a DC bus voltage with the VSD, obtaining a data batch of the sampled measurements, calculating a set of descriptive features of the batch with the VSD, and determining whether at least one descriptive feature exceeds a predetermined threshold value. The VSD sends the set of descriptive features and data batch to the cloud environment for classifying one or more power quality events using a machine learning model.

### FIELD OF THE DISCLOSURE

The present disclosure relates to systems, methods, and devices for evaluating power quality events on a variable speed drive system.

### BACKGROUND

Power quality disturbances cause a variety of issues in industrial facilities. Industrial facilities are prone to power quality disturbances because of the complex electrical equipment involved in daily operations. Without a solution for identifying what is at fault, e.g., the electric utility of the facility or facility equipment, additional time and energy are spent investigating the cause of the problem, leading to delays in production and service.

Electric power quality measures the degree to which a power supply system's voltage, frequency, and waveform conform to predefined specifications. Good power quality provides a steady supply voltage that stays within an established range, a steady frequency close to the rated value, and/or a smooth voltage curve waveform.

While improper installation, defective equipment, or faulty wiring may cause such disturbances, certain applications common to industrial facilities can result in power quality disturbances through daily use. Such applications include those with electric motors and variable speed drives (VSDs). Electric motors are present in most commercial applications and, in some industries, comprise up to 80% of a facility's electrical load. A VSD controls energy flow from the main electrical supply to the motor in many commercial applications. Power quality disturbances that create issues for VSDs include voltage sags, voltage swells, and interruptions. Sags may be caused by the activity of large consumers on the grid (e.g., the startup of a 5MW motor directly connected to the grid). Swells may be related to a sudden stop of a large consumer but also due to a lightning strike hitting the grid some miles away. Interruptions could be due to various causes, e.g., a construction worker digging with his excavator into a cable or switching off due to overload elsewhere on the grid.

Existing prior art systems have attempted to monitor power quality by processing measurement data directly from the three-phase voltages. However, this approach requires the added cost of extra sensors and other measurement equipment. These extra sensors are typically required to monitor power quality events on a system's (e.g., 3-phase) grid side. Additionally, regarding the distinction of fault between the electric utility of the facility versus equipment, equipment suppliers do not have a way to document or identify the source of the fault without extra sensors placed on the grid side of the system.

As such, there is a need for an improved system and method for monitoring power quality events, particularly in VSD applications, to identify route causes for power quality disturbances without the added cost of extra sensors and other measurement equipment.

### SUMMARY

For proper motor control, the variable speed drive (VSD) requires a stable voltage on the DC bus. Grid events can impact this stability and, in severe cases, cause the drive to go into alarm. The inventors of the present disclosure have developed a novel technique to monitor power quality based on DC bus voltage measurements. Advantageously, these measurements are directly obtained from and included with the VSD to drive the motor. The disclosure relates to a system and method for monitoring power quality events with a VSD electrically connected to a 3-phase electrical supply grid and an electric motor. The VSD includes at least one sensor connected to a DC bus, arranged between a rectifier and an inverter, to obtain instantaneous voltage measurements of the DC bus voltage.

The VSD obtains a data batch of the sample measurements using a computing unit of the VSD, wherein the VSD acts as an edge device between a physical system (e.g., compressor system with at least one motor) and a cloud environment. The data batch is a snapshot measurement of the DC bus voltage at a predefined sample rate for a predetermined time period.

Based on the data batch, multiple descriptive features are calculated by the VSD. The descriptive features include descriptive statistics that are unique to each data batch, including but not limited to minimum, mean, and maximum voltages. A set (or subset) of descriptive features may also include standard deviations of other descriptive features from the same data batch. Using an anomaly detection algorithm, the VSD determines whether at least one descriptive feature from the set of descriptive features of the data batch exceeds a predetermined threshold value. If the threshold for a descriptive feature is not exceeded, the process restarts. In other words, the anomaly detection algorithm in the VSD may prevent the data batch and/or the descriptive features from being sent to a cloud environment to save processing time and costs for both cloud memory and wireless transmission. If the threshold for a descriptive feature is exceeded, then the data (i.e., snapshot), including the descriptive features, is transmitted to the cloud environment, and the computing unit restarts the process at the VSD level to acquire new measurements.

Because the VSD has direct access to high-frequency data from the sensors, it can perform initial calculations on the measured data in real-time with the computing unit. The VSD does not analyze the sample voltage measurements from the DC bus in depth. Instead, to minimize the required processing power for power quality monitoring, the voltage snapshot is classified into a particular type of power quality event that occurs remotely in the cloud environment.

When the cloud environment receives a data batch, a machine learning model classifies the power quality event based on the descriptive features associated with the data batch. Classification by the machine learning model may further be based on raw data from the data batch and/or on other descriptive features that were not yet computed (or more difficult to compute) with the computing unit of the VSD. The cloud environment classifies each data batch as having one or more power quality events based on the descriptive features. In particular, the machine learning model can distinguish the descriptive features between different grid events, including voltage sag, voltage swell, interruptions, or standard behavior. This capability can be extended to detect other grid events and whether the event occurred in multiple phases of the supply grid or not. In an embodiment, the machine learning model generates a probability for each potential event (e.g., the sum of probabilities is one and when an event is more certain to have occurred, its corresponding probability may outweigh other possible events). At the end of each classification by the machine learning model, the data batch, descriptive features, and the classified type of power quality event are all stored together i.e., in cloud storage.

The cloud environment may generate data display visualizations (e.g., graphs and charts) and actionable notifications (e.g., diagnostic reports) based on the power quality events that may be transmitted to various parties (i.e., suppliers, customers, third parties) and may also be returned to the same VSD to update various parameters, including sampling rates, threshold values, etc. Advantageously, the system and method provide value to users, including suppliers and customers, regarding information about problematic power quality events during the operation of motors and their corresponding machines.

This summary is provided to introduce a selection of concepts in a simplified form that are further described below in the Detailed Description. These and other features, aspects, and advantages of the present disclosure will be better understood in the following description, appended claims, and accompanying drawings.

### BRIEF DESCRIPTION OF THE DRAWINGS

A more particular description of the embodiments briefly described above will be rendered by reference to specific embodiments, which are illustrated in the appended drawings to describe how the advantages and features of the systems and methods described herein can be obtained. Understanding that these drawings depict only typical embodiments of the systems and methods described herein, and are not therefore considered to be limiting of their scope, certain systems and methods will be described and explained with additional specificity and detail through the use of the accompanying drawings in which:

FIG. 1 illustrates an exemplary system for monitoring power quality events using a variable speed drive (VSD).

FIG. 2 illustrates how the VSD processes measured voltage data.

FIG. 3 illustrates an exemplary snapshot of measured voltage data including some corresponding descriptive features.

FIG. 4 illustrates how the cloud environment processes data received from the VSD.

FIG. 5 illustrates an exemplary flowchart of the method for monitoring power quality events with distinct steps executed at the VSD and cloud environment levels.

### DEFINITIONS

A description of a few terms is necessary for ease of understanding the disclosed embodiments of the disclosed method and system elements.

The term “cloud” or “cloud environment” refers to all cloud offerings and infrastructure-as-a-service (IaaS), as well as all platform-as-a-service (PaaS) and software-as-a-service (SaaS) applications. A cloud environment may encompass hardware, software (including hardware and software configuration), networking, and executing workloads. The term “cloud environment” may also encompass a cloud storage or cloud service storage, which enables convenient, on-demand network access to configurable computing resources (e.g., networks, servers, applications) that can be rapidly executed with minimal management or provider interaction.

The term “compressor” refers to a machine that draws low-pressure gas from auxiliary storage as raw input and then outputs high-pressure gas for storage or to feed other processes. The terms “compressor” and “compressor elements” are not intended to be limiting in scope and may refer to positive displacement compressors and/or turbocompressors and/or individual components of compressors.

The term “computer storage media” refers to physical storage media that store computer-executable instructions and/or data structures. Storage media, such as a digital data carrier, includes computer hardware, such as random-access memory (RAM), read-only memory (ROM), electrically erasable programmable ROM (EEPROM), solid state drives (SSDs), flash memory, phase-change memory (PCM), optical disk storage, magnetic disk storage, and the like.

The term “controller” generally refers to a computerized command terminal comprising sensors and electrical components to regulate various compressor instruments or elements, e.g., variable speed drives (VSDs). In general, controllers include or are electrically connected to at least one main computing unit with a graphical interface and are adapted to monitor the instrumentation of various compressor components (e.g., motors, rotors, filters, bearings, valves, pressure sensors, temperature sensors), including multiple compressors. Exemplary controllers operate to collect data from sensors within the VSD and/or motor, processing said and delivering an overview. Controllers may be connected to mobile devices, such as tablets and smartphones, to allow for mobile monitoring over a secure network. Controllers may also allow for over-the-air updates from a service or cloud environment.

The term “network” refers to one or more data links that enable the wired or wireless transport of electronic data between computer systems and/or cloud environments and/or modules and/or other electronic devices.

The term “processor” or “computing unit” refers to one or more devices, circuits, and/or processing cores configured to process data, such as computer program instructions, and includes personal computers, computing units, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Unless otherwise stated, references to a first processor may also apply to a second processor and vice versa.

The term “service” refers to an automated program that performs different actions based on input. As used herein, the terms “executable module,” “executable component,” “component,” “module,” “service,” or “engine” can refer to hardware processing units or to software objects, routines, or methods that may be executed with the system.

The term “software” generally refers to computer-executable instructions, code, data, applications, programs, program modules, or the like maintained in or on any form or type of computer-readable media that is configured for storing computer-executable instructions or the like in a manner that is accessible to a computing device.

As used herein, reference to any machine learning or artificial intelligence may include any machine learning algorithm or device, convolutional neural network(s), multilayer neural network(s), recursive neural network(s), recurrent neural network(s), deep neural network(s), decision tree model(s) (e.g., decision trees, random forests, and gradient boosted trees), linear regression model(s), logistic regression model(s), support vector machine(s) (SVM), artificial intelligence device(s), or any other type of intelligent computing system. Any training data may be used (and perhaps later refined) to train the machine learning algorithm to perform the disclosed operations dynamically.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

### DETAILED DESCRIPTION

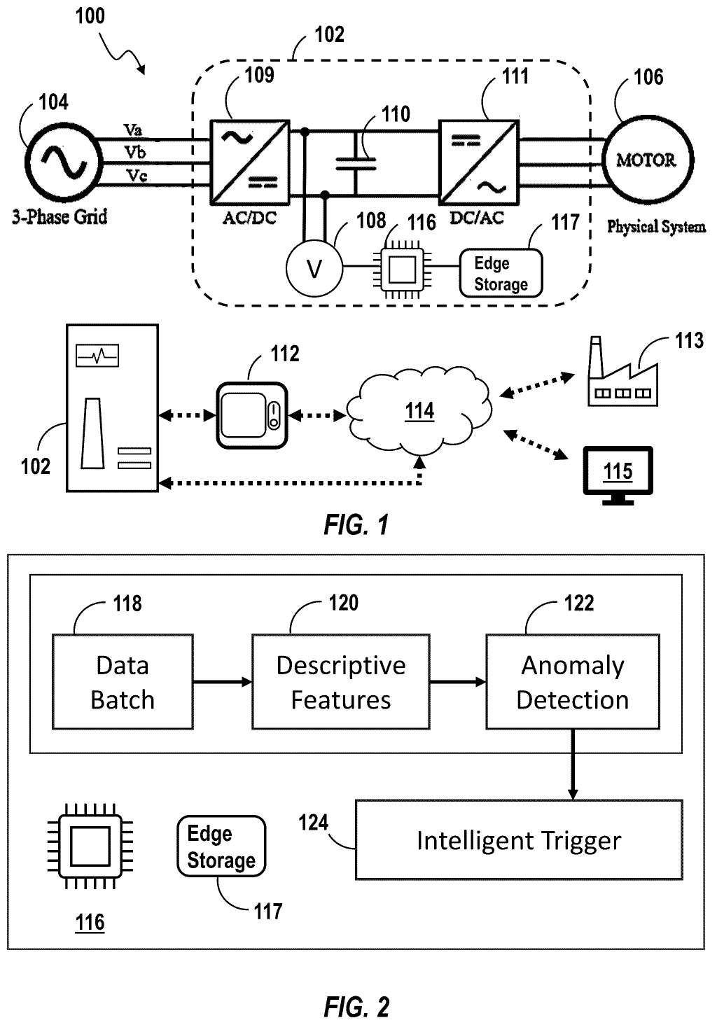

FIG. 1 illustrates an exemplary system 100 for monitoring power quality events. The system 100 includes a variable speed drive (VSD) 102 that is electrically connected to an electrical supply grid 104 and an electric motor 106 (e.g., compressor machine). The electrical supply grid 104 supplies electricity to the VSD 102, which powers at least one motor 106. In a preferred embodiment, the electrical supply grid 104 is a 3-phase electrical supply grid. The motor 106 can drive a corresponding compressor, pump, or fan. In an embodiment, the electrical supply grid 104 provides a multi-phase (e.g., three-phase) fixed AC voltage to the VSD 102. In an embodiment, the electrical supply grid 104 can supply an AC voltage of 250 V to 650 V, at a line frequency of approximately 50 Hz (or 60 Hz), to the VSD 102, depending on the corresponding power grid.

The VSD 102 drives and adjusts the speed (e.g., RPM) of the motor 106. In an embodiment, the VSD 102 includes at least one rectifier 109 to convert incoming AC voltage from the electrical supply grid 104 into DC voltage. After the power from the electrical supply grid 104 flows through the rectifier 109, it passes over a DC bus 110 to stabilize the DC voltage. The DC bus 110 contains capacitors to receive power from the rectifier 109 and deliver power to the motor 106 through at least one inverter 111. The DC bus 110 may also contain inductors, called DC chokes, which add inductance to smooth the incoming power from the electrical supply grid 104.

One or more (voltage) sensors 108 of the VSD 102 used to drive the motor 106 are directly connected to the DC bus 110 to obtain voltage measurements. Because the system 100 uses the sensors 108 of the VSD 102, the system 100 bypasses the step of processing voltage measurement data directly from the electrical supply grid 104. Measuring the voltage of the DC bus 110 provides a more constant variable than the phase voltages of the electrical supply grid 104, which are sinusoidal. This advantageously avoids the cost of supplying separate sensors on the “grid side,” i.e., at the electrical supply grid 104 source, and the sensors 108 dually serve to aid the VSD 102 in driving the motor 106 and obtaining measurements for monitoring power quality events.

In an embodiment, the VSD 102 is connected to a controller 112 for monitoring the instrumentation of various elements associated with the motor 106, VSD 102, and/or compressor, including rotors, filters, bearings, valves, pressure sensors, temperature sensors, multiple compressors, and the like. The computing unit 116 collects sample measurements from the sensors 108 of the VSD 102 and is communicatively connected to the controller 112 of the VSD 102. The controller 112 may also include a display interface or graphical touch-screen interface for directly controlling the VSD 102 and displaying readings or indicators of the various elements associated with the motor 106, VSD 102, and/or compressor.

In an embodiment, the VSD 102 does not analyze (i.e., classify) the sample voltage measurements from the DC bus 110 in depth. The voltage measurements are classified as power quality events in a cloud environment 114 to minimize the local required processing power for power quality monitoring. The VSD 102, along with the computing unit 116, acts as an edge device to read out the voltage from the DC bus 110 at a high sample rate (e.g., 1 kHz) and to check whether a power quality event occurred based on the sample voltage measurements. The sampling rate can vary between 100 Hz and 1 MHz. Based on the sampled voltage measurements, the computing unit 116 determines whether to send the sampled voltage measurements to the cloud environment 114 for further processing. In an embodiment, the computing unit 116 comprises an edge Single-Board Computer (SBC) arranged as an interface between the physical system (e.g., VSD 102 and motor 106) environment and cloud environment 114. In an embodiment, the controller 112 sends data (e.g., data batch 118) to the cloud environment 114 via (e.g., wireless) data transmission. In an alternative embodiment, the VSD 102 itself can perform data transmission to send data to the cloud environment 114 directly.

By performing the classification analysis of power quality events in the cloud environment 114, the influence on the processing power for a VSD's primary function, i.e., driving the motor, is unaffected. Based on a machine learning algorithm, the classifications of power quality events occurring in the cloud environment 114 are then delivered to the user of the VSD 102, a supplier 113, e.g., of VSDs, and/or third-party service 115. The information from the cloud environment 114 based on the resulting classification is used to inform one or more parties of what type of power quality event occurred in connection with the VSD 102. In an alternative embodiment, the voltage snapshot is classified locally into a particular type of power quality event using a computing unit 116 of the VSD 102 with sufficient processing capability and power.

The disclosed system 100 provides actionable notifications to either show users or customers of VSDs 102 whether certain power quality events are happening frequently due to the electrical supply grid 104 connection or, in an embodiment, as a result of issues of the motor 106. If certain problematic power quality events happen frequently, the actionable notifications may include instructions to avoid or correct problems occurring with the VSD 102 machine and potentially other machines.

In an embodiment of the system 100, at least two motors 106 are arranged next to each other in parallel, e.g., electrically close (i.e., connected to the same supply transformer), wherein at least one motor 106 is directly connected to the electrical supply grid 104. For example, the system may use the power quality evaluation on a first motor to also get an idea about the power quality at a neighboring second motor. At least one motor 106 is part of a fixed-speed machine in an embodiment. At least one VSD 102 may be used as a collective sensor for the power quality applied to multiple motors 106 from the same electrical supply grid 104. Advantageously, the system 100 provides value to users, including suppliers and customers, regarding information about problematic power quality events for multiple machines and motors 106.

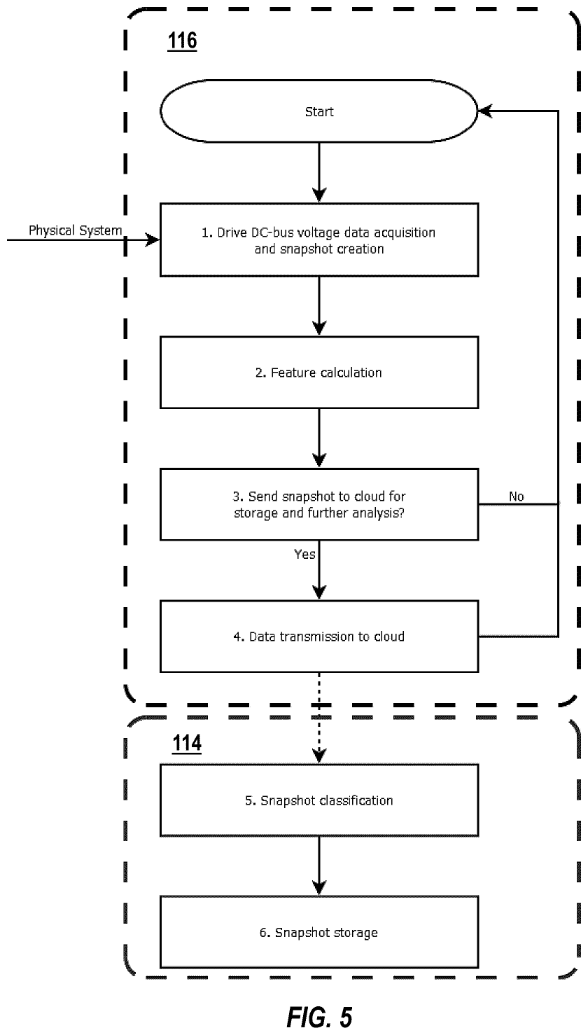

FIG. 2 shows how the computing unit 116 of the VSD 102 handles sample voltage data from the sensors 108. The computing unit 116 reads out sample voltage measurements of the DC bus 110 from the sensors 108 and collects a “snapshot” or data batch 118 of sample voltage measurements. The snapshot duration can vary from 10 ms to 600 s (10 min). Each data batch 118 is a snapshot of sample measurements and can contain a predetermined duration of readings at a predefined sample rate, e.g., 1 second of voltage measurements at a sample rate of 1 kHz. In an embodiment, the computing unit 116 includes a storage device 117 for storing instructions executable by the computing unit 116. Such instructions include the steps and features outlined in FIGS. 2 and 5. The storage device 117 is a computer storage media.

Based on the data batch 118, the computing unit 116 extracts descriptive features 120 of the sample voltage measurements from the DC bus 110. These descriptive features 120 may include minimum, mean, and maximum values of the sample voltage measurements from the data batch 118. In an embodiment, multiple sets (or subsets) of descriptive features 120 are calculated from the data batch 118. One skilled in the art will recognize that the descriptive features 120 can be calculated using alternative calculations (i.e., mean can be calculated by a median calculation, and a peak-to-peak calculation can calculate standard deviation). The disclosure does not intend to limit the calculation of descriptive features to a certain method. In an embodiment, the first set of descriptive features 120 includes minimum, mean, and maximum values of the sample voltage measurements. In an embodiment, the first set of descriptive features is calculated for every 5 ms to 300 s, preferably 100 ms, of the data batch 118. A second set of descriptive features 120 includes standard deviations of descriptive features 120 (i.e., minimum, mean, and maximum) over the entire duration of the data batch 118. In an embodiment, the second set of descriptive features 120 includes standard deviations of the descriptive features 120 from the first set.

Following the extraction of descriptive features 120, the computing unit 116 uses an anomaly detection function 122 to determine whether one or more descriptive features 120 exhibits an anomalous or irregular reading. An anomalous or irregular reading may be determined using a predefined threshold that represents an absolute value above or below which an event is generated. The computing unit 116 thus determines whether at least one calculation from the set of descriptive features 120 exceeds a predetermined threshold value to trigger the intelligent trigger mechanism 124. In an embodiment, the threshold may be updated as a result of training or historical readings of the system 100. In an embodiment, the operations of the anomaly detection function 122 and intelligent trigger mechanism 124 concurrently occur when it is determined whether the predetermined threshold value is exceeded.

When an anomalous or irregular reading is not determined from the anomaly detection function 122, the computing unit 116 proceeds to obtain a data batch 118 for subsequent sample measurements, calculates new descriptive features 120 and uses the anomaly detection function 122 to determine whether the new descriptive features 120 exhibit an anomalous or irregular reading. When an anomalous or irregular reading is determined from the anomaly detection function 122, the sample voltage measurements, including descriptive features 120, are transferred to the cloud environment 114. In an embodiment, the computing unit 116 uses an intelligent trigger mechanism 124 to transfer data pertaining to threshold-triggered events, e.g., descriptive features 120 of anomalous or irregular readings, to the cloud environment 114 for further processing and analysis.

Advantageously, steps and elements of FIG. 2 are executed at the VSD 102 itself, acting as an edge device. The VSD 102 has direct access to high-frequency data from the sensors 108 and can perform initial calculations on this data in real-time with the computing unit 116. The VSD 102 is thus configured to determine when and whether a power quality event occurs and sends only the relevant data (i.e., sample voltage measurements of the data batch 118 and descriptive features 120) without interrupting the task of the VSD 102 to drive the motor 106 continually.

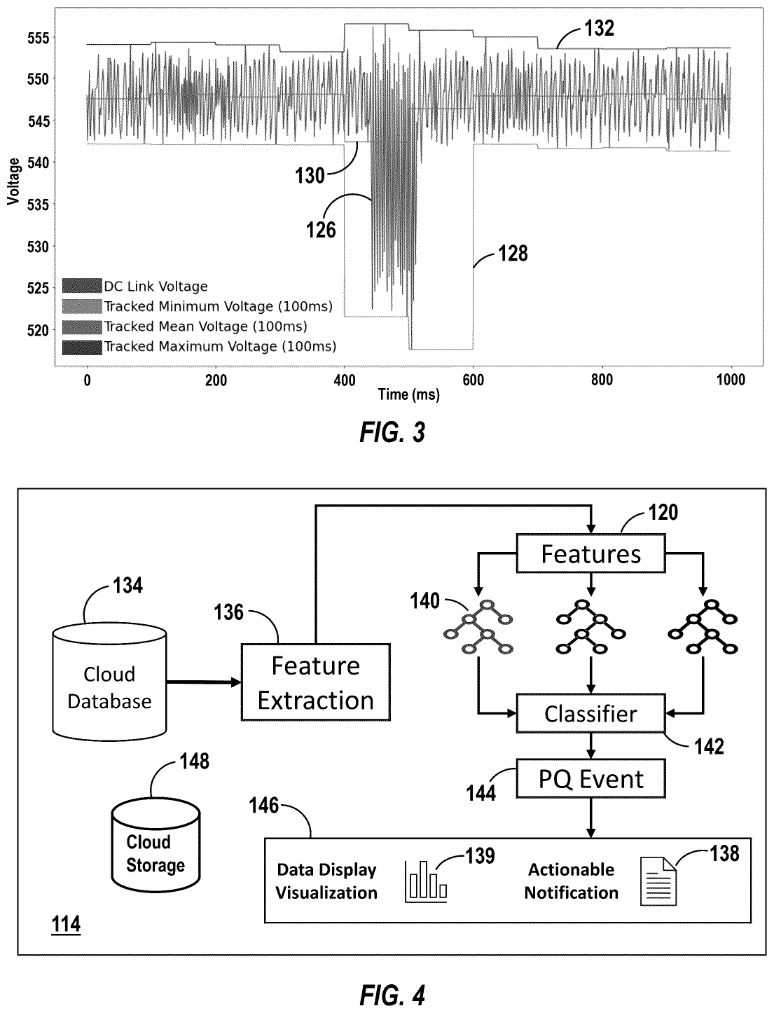

FIG. 3 illustrates a graphical representation of a snapshot or data batch 118 obtained by the computing unit 116 of the VSD 102. The data batch 118 includes readings of the DC bus voltage 126 obtained over a period of time, e.g., 1000 ms. The descriptive features 120 of the data batch 118 include a tracked minimum voltage 128, a tracked mean voltage 130, and a tracked maximum voltage 132. These descriptive features 120 are calculated for every 100 ms of the data batch 118.

One skilled in the art will recognize that other descriptive statistics may be calculated and utilized, including modes, ranges, variances, and interquartile ranges for each data batch 118. Sampling rates and data batch durations may also vary depending on the application. In an embodiment, sample rates and data batch durations are arranged to adjust in real-time based on output from analysis determined at the computing unit 116 and/or cloud environment 114 level.

In an embodiment, the computing unit 116 is arranged to transfer the data batch 118, including the descriptive features 120, if at least one of three standard deviations for minimum, mean, and maximum voltages exceeds a certain threshold, wherein the processes of data batching, feature extraction, and anomaly detection are otherwise configured to repeat. Said processes are repeated on the VSD 102 after sending a data batch 118 and descriptive features 120 to the cloud environment 114. In addition to the data batch 118 and descriptive features 120, other relevant information sent to the cloud environment may include other details pertaining to voltage measurements and the VSD 102.

In an embodiment wherein the data batch 118 is arranged to be transmitted to the cloud environment 114, the descriptive features 120 of the data batch 118 are withheld from being transferred to the cloud environment 114 to reduce the transmission cost by sending less information.

FIG. 4 provides an exemplary representation of how the cloud environment 114 processes the data batch 118 and descriptive features 120 received from the computing unit 116. Information between the computing unit 116 of the VSD 102 and the cloud environment 114 can be exchanged using a wireless network, such as Wi-Fi, cellular network, or other wired network. Additionally, such wireless transmission functionality can be provided by the controller 112, positioned between the computing unit 116 and the cloud environment 114, and/or directly from the VSD 102 to the cloud environment 114. After the cloud environment 114 receives the data batch 118 and descriptive features 120, the data batch 118 and descriptive features 120 are stored in a cloud database 134. After feature extraction 136 is performed on the cloud database 134, the descriptive features 120, and/or data batch 118, are processed in a machine learning model 140.

The machine learning model 140 analyzes the descriptive features 120 to categorize said descriptive features 120, and corresponding data batch 118, as a power quality event 144. In an embodiment, the machine learning model 140 is a random forest algorithm that distinguishes between different power quality events 144. The machine learning model 140 may include multiple decision trees and implement a classifier 142, e.g., majority voting functionality, to classify the descriptive features 120 as meeting predetermined criteria to qualify as a power quality event 144. In an embodiment, the machine learning model 140 includes deep learning techniques (e.g., convolutional neural network (CNN)) on the data batch to classify power quality events. In another embodiment, combinations of raw data from the data batch 118 and the processed descriptive features 120 are fed into the classifier 142.

The resulting power quality event 144 is based on the descriptive features 120. The power quality event 144 may be classified as a voltage sag, voltage swell, interruption, or standard (i.e., normal) behavior. The machine learning model 140 may be used to detect other grid events, including spikes, overvoltage, undervoltage, voltage surge, harmonics, flicker, unbalance, transients, and frequency deviations using the raw data from the data batch 118 with or without the locally processed (i.e., not in the cloud environment 114) descriptive features 120. In an embodiment, the machine learning model 140 may further be used to detect whether the power quality event 144 occurred in all three electrical supply grid 104 phases.

In the end, the data batch 118, the descriptive features 120, and the type of grid event 144 are all stored together, e.g., in a data storage architecture 148. In an embodiment, the data storage architecture 148 stores instructions that are executable within the cloud environment 114 to perform a variety of cloud computing processes. The cloud computing model 146 generates an actionable notification 138 that may be sent to the user of the VSD 102, a supplier 113, e.g., of VSDs, and/or third-party service 115. The cloud environment 114 includes a cloud computing model 146 for generating data display visualization 139 of the power quality event 144 and reporting the power quality events 144, e.g., including harmonic disturbances.

The system 100 can be extended to allow communication from the cloud environment 114 to the computing unit 116 of the VSD 102. In an embodiment, the predetermined thresholds for determining irregular or anomalous readings can be changed automatically or manually to increase or decrease the sensitivity of the anomaly detection function 122 and intelligent trigger mechanism 124. This is particularly useful when a large quantity of data is already available from a certain grid, and no more input is needed, limiting the amount of data transmitted to and stored in the cloud environment 114.

Because the steps of classification (via machine learning model 140) and storing the complete data batch 118 and descriptive features 120 require more processing power and storage memory than what is traditionally offered by a VSD 102, the cloud environment 114 can better handle and perform these steps. This way, cloud environment 114 capabilities add more value to the VSD 102 without adding extra components and increasing material costs.

FIG. 5 illustrates an exemplary flow chart of the method executed by the system 100 between the computing unit 116 and cloud environment 114. The DC bus voltage measurements are initially obtained from the VSD to create a snapshot of voltage sample measurements. Descriptive features of the snapshot are then created. The computing unit 116 then determines whether to send the snapshot to the cloud environment 114 for storage and further analysis. The process restarts if the threshold for a descriptive feature 120 is not exceeded. In other words, the VSD 102 prevents the descriptive features 120 from being sent to a cloud environment 114 to save computation and processing time and avoid redundant calculations or classifications in the cloud environment 114. If the threshold for a descriptive feature 120 is exceeded, then the data (i.e., snapshot) is transmitted to the cloud environment 114, and the computing unit 116 restarts the process at the level of the VSD 102 to acquire new measurements. After the data is transmitted to the cloud environment 114, the snapshot is classified using a machine learning algorithm and stored in the cloud environment. The classified snapshot is subsequently prepared to report to users, including users of the VSD 102, suppliers 113, and other third-party services 115. In an embodiment, once sufficient information becomes available, the VSD 102 may be informed about the update/upgrade of (threshold) limit values to upgrade the anomaly detection algorithm with more appropriate parameters over time.

It will be understood that although the terms first, second, etc. may be used herein to describe various elements, these elements should not be limited by these terms. These terms are only used to distinguish one element from another. For example, a first element could be termed a second element. Similarly, a second element could be termed a first element without departing from the scope of the present invention. As used herein, the term “and/or” includes any and all combinations of one or more of the items in the associated list. It is further understood that the use of relational terms such as first and second, and the like are used solely to distinguish one entity from another without necessarily requiring or implying any actual such relationship or order between such entities.

It is to be understood that even though numerous characteristics and advantages of various embodiments of the present disclosure have been set forth in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1. A method for monitoring power quality events in an electrical system including a variable speed drive (VSD) electrically connected to a 3-phase electrical supply grid and an electric motor, the method comprising:
sampling measurements of a DC bus voltage of the VSD;
obtaining a batch of the sampled measurements using a computing unit of the VSD;
calculating a set of descriptive features of the batch;
determining that at least one calculation from the set of descriptive features exceeds a predetermined threshold value;
sending the batch and/or set of descriptive features to a cloud environment;
classifying the batch as a power quality event based on the set of descriptive features; and
providing an actionable notification and data visualizations indicating a classified power quality event;
wherein steps occurring before sending the batch and/or set of descriptive features to the cloud environment are executed by the VSD itself.

2. The method of claim 1, wherein the set of descriptive features includes standard deviations of the sampled measurements of the batch and wherein the step of determining that at least one calculation from the set exceeds the predetermined threshold value includes determining that at least one standard deviation from the set exceeds the predetermined threshold value.

3. The method of claim 1, wherein the batch contains sample measurements from a predetermined duration at a predefined sampling rate of the DC bus voltage.

4. The method of claim 1, wherein the set of descriptive features includes a first subset of descriptive features and a second subset of descriptive features.

5. The method of claim 4, wherein at least one of the first subset of descriptive features and the second subset of descriptive features include minimum, mean, and maximum values of the DC bus voltage for multiple sample measurements of the batch.

6. The method of claim 1, wherein the step of sampling measurements of the DC bus voltage of the VSD is performed by one or more sensors and computing unit of the VSD.

7. The method of claim 1, wherein after determining that at least one calculation from the set exceeds the predetermined threshold value, the method further comprises steps of obtaining a new batch of sampled measurements and calculating a new set of descriptive features of the new batch.

8. The method of claim 1, wherein the step of classifying the batch as the power quality event includes using a machine learning model to define the power quality event based on the set of descriptive features.

9. The method of claim 1, wherein the step of classifying the batch as the power quality event includes identifying the power quality events as a voltage sag, a voltage swell, an interruption, or standard event.

10. The method of claim 1 further comprising the step of storing the set of descriptive features and the classified power quality event together with the batch in the cloud environment.

11. The method of claim 1, wherein the step of providing the actionable notification indicating the classified power quality event includes sending the actionable notification to at least one of the VSD, a supplier of VSDs, and a remote service.

12. A system for monitoring power quality events, the system comprising:
a variable speed drive (VSD) electrically connected to a 3-phase electrical supply grid and an electric motor;
a computing unit housed within the VSD and connected to a cloud environment; and
one or more hardware storage devices that store instructions that are executable to cause the computing unit to:
sample measurements of a DC bus voltage;
obtain a batch of the sampled measurements;
calculate a set of descriptive features of the batch, wherein the set includes standard deviations of the sampled measurements of the batch;
determine that at least one standard deviation from the set exceeds a predetermined threshold value; and
send the set of descriptive features to the cloud environment;
wherein the cloud environment includes a machine learning model for classifying the batch as a power quality event based on the set of descriptive features.

13. The system of claim 12, wherein the set of descriptive features includes a first subset of descriptive features and a second subset of descriptive features.

14. The system of claim 13, wherein the first subset of descriptive features includes minimum, mean, and maximum values of the DC bus voltage for multiple sample measurements of the batch and the second subset of descriptive features includes standard deviations of minimum, mean, and maximum values of the DC bus voltage for the batch.

15. The system of claim 12, wherein the machine learning model is configured as a random forest algorithm.

16. The system of claim 12, wherein the machine learning model is arranged for classifying the power quality event as a voltage sag, a voltage swell, an interruption, or standard event.

17. The system of claim 12, wherein the machine learning model provides an actionable notification indicating the power quality event to at least one of the VSD, a supplier of VSDs, and a remote service.

18. The system of claim 12, wherein the VSD includes at least one sensor connected to a DC bus arranged between a rectifier and an inverter to obtain the sample measurements of the DC bus voltage.

19. A method for monitoring power quality events in an electrical system including a variable speed drive (VSD) electrically connected to a 3-phase electrical supply grid and an electric motor, the method comprising:
sampling measurements of a DC bus voltage of the VSD;
obtaining a first batch of sampled measurements using a computing unit of the VSD;
calculating a first set of descriptive features of the first batch;
determining that none of the descriptive features of the first batch exceeds a predetermined threshold value; and
preventing the first set of descriptive features and the first batch from being sent to a cloud environment.

20. The method of claim 19 further comprising:
obtaining a second batch of sampled measurements;
calculating a second set of descriptive features of the second batch;
determining that at least one descriptive feature from the second set exceeds the predetermined threshold value;
sending the second set of descriptive features to the cloud environment;
classifying the second batch as a power quality event based on the second set of descriptive features; and
providing an actionable notification indicating a classified power quality event based on the second batch;
wherein steps occurring before sending the second set of descriptive features to the cloud environment are executed by the VSD itself.
